(19) United States
(12) Patent Application Publication
(10) Pub. No.: US 2026/0316566 A1
(43) Pub. Date: Oct. 15, 2026

(54) Method for Operating a Digital Assistant of a Vehicle, Computer-Readable Medium, System and Vehicle

(71) Applicant: Bayerische Motoren Werke Aktiengesellschaft, Muenchen (DE)

(72) Inventor: Mathias Ordung, Muenchen (DE)

(21) Appl. No.: 19/484,344

(22) PCT Filed: Apr. 18, 2024
(86) PCT No.: PCT/EP2024/060466

§ 371 Date: Nov. 13, 2025

(30) Foreign Application Priority Data
Jun. 14, 2023 (DE) 10 2023 115 462.1

(51) Int. Cl. B60K 35/28; B60K 35/10; B60K 35/85

(52) U.S. Cl. CPC B60K 35/28; B60K 35/10; B60K 35/85

(57) ABSTRACT

The present disclosure relates to a method for operating a digital assistant of a vehicle, wherein the digital assistant comprises a rule-based dialogue system and a dialogue system based on artificial intelligence. The method includes activating a dialogue-based user guidance of the rule-based dialogue system on a function of the vehicle by way of the rule-based dialogue system of the digital assistant. The method further includes providing a first message of the dialogue-based user guidance by way of the rule-based dialogue system of the digital assistant to a user of the vehicle after the activation of the dialogue-based user guidance. Additionally, the method includes transferring the first message of the dialogue-based user guidance from the rule-based dialogue system of the digital assistant to the dialogue system of the digital assistant based on artificial intelligence as context information. The method further includes receiving a message of the user during the dialogue-based user guidance of the rule-based dialogue system by way of the rule-based dialogue system of the digital assistant, and transferring the message of the user from the rule-based dialogue system of the digital assistant to the dialogue system of the digital assistant based on artificial intelligence.

### CROSS-REFERENCE TO RELATED APPLICATIONS

The present application is the U.S. national phase of PCT Application PCT/EP2024/060466 filed on Apr. 18, 2024, which claims priority from German patent application No. 10 2023 115 462.1 filed on Jun. 14, 2023, the entire contents of which are incorporated by reference herein.

### FIELD

The present disclosure relates to the field of vehicles, and more particularly to a method for operating a digital assistant of a vehicle. The disclosure furthermore relates to a computer-readable medium for operating a digital assistant of a vehicle, a system for operating a digital assistant of a vehicle, and a vehicle comprising the system for operating a digital assistant of a vehicle.

### BACKGROUND

Digital assistants of vehicles which enable rule-based dialogues for vehicle functions are known from the prior art. Furthermore, digital assistants based on artificial intelligence are known. A combination of a rule-based digital assistant and a digital assistant based on artificial intelligence in the vehicle is not known from the prior art.

It would be advantageous to operate a digital assistant more efficiently. In particular, it would be advantageous to provide improved response messages on a function of a vehicle by a digital assistant of the vehicle to a user of the vehicle.

### SUMMARY

According to a first aspect, the disclosure is distinguished by a method for operating a digital assistant of a vehicle, wherein the digital assistant comprises a rule-based dialogue system and a dialogue system based on artificial intelligence. The method can be a computer-implemented method and/or a controller implemented method. The dialogue system based on artificial intelligence can be, for example, a chatbot, which uses an artificial intelligence in order to generate text-based and/or speech-based response messages to messages of a user. The digital assistant can be a digital speech assistant. The rule-based dialogue system preferably comprises a predetermined dialogue sequence defined by one or more rules. The rule-based dialogue system can directly process a status datum, status data, a sensor datum, and/or sensor data on a function of the vehicle, for example by a rule and/or a data processing module of the rule-based dialogue system. The dialogue system based on artificial intelligence is preferably text-based and/or speech-based. For example, the dialogue system based on artificial intelligence cannot directly process function-specific status and/or sensor data, i.e. it is necessary to convert the function-specific status and/or sensor data into a text format comprehensible to the dialogue system based on artificial intelligence.

The method comprises activating a dialogue-based user guidance of the rule-based dialogue system on a function of the vehicle by the rule-based dialogue system of the digital assistant. The method furthermore comprises providing a first message of the dialogue-based user guidance by the rule-based dialogue system of the digital assistant to a user of the vehicle after the activation of the dialogue-based user guidance, and transferring the first message of the dialogue-based user guidance from the rule-based dialogue system of the digital assistant to the dialogue system of the digital system based on artificial intelligence as context information. Furthermore, the method comprises receiving a message of the user during the dialogue-based user guidance of the rule-based dialogue system by the rule-based dialogue system of the digital assistant, and transferring the message of the user from the rule-based dialogue system of the digital assistant to the dialogue system of the digital assistant based on artificial intelligence. The method recognizes an intent of the dialogue-based user guidance of the rule-based dialogue system on the function of the vehicle depending on the received message of the user by the rule-based dialogue system of the digital assistant. If no intent of the dialogue-based user guidance of the rule-based dialogue system on the function of the vehicle has been recognized by the rule-based dialogue system of the digital assistant, the method provides a context-based response message to the user of the vehicle by the dialogue system of the digital assistant based on artificial intelligence using the transferred context information and depending on the transferred message of the user. If an intent of the dialogue-based user guidance of the rule-based dialogue system on the function of the vehicle has been recognized by the rule-based dialogue system of the digital assistant, the method provides a response message to the user of the vehicle depending on the recognized intent of the dialogue-based user guidance of the rule-based dialogue system on the function of the vehicle by the rule-based dialogue system of the vehicle.

The method can advantageously operate a digital assistant, such as a digital speech assistant, more efficiently. A user of the vehicle can, due to the combination of the rule-based dialogue system with the dialogue system based on artificial intelligence, receive a context-based response message provided by the dialogue system based on artificial intelligence by way of the method, wherein the rule-based dialogue system provides the context for the context-based response message of the dialogue system based on artificial intelligence. The user can therefore receive a more precise response message by way of the dialogue system based on artificial intelligence to a message of the user, the intent of which is not recognized by the rule-based dialogue system and/or is not recognized with a confidence above a predetermined confidence threshold value. Furthermore, the method efficiently prevents an unsuitable response message and/or an incorrect response message of the dialogue system based on artificial intelligence in that the rule-based dialogue system defines the context of the dialogue system based on artificial intelligence.

According to one advantageous design, activating the dialogue-based user guidance on the function of the vehicle by the rule-based dialogue system of the digital assistant can comprise providing a recommendation message on a function of a vehicle by way of the rule-based dialogue system of the digital assistant to a user of the vehicle, transferring the recommendation message to the dialogue system based on artificial intelligence as context information, receiving a confirmation message of the user of the vehicle in response to the provided recommendation message by way of the rule-based dialogue system of the digital assistant to activate the dialogue-based user guidance on the function of the vehicle, activating the dialogue-based user guidance of the function of the vehicle by way of the rule-based dialogue system of the digital assistant, and transferring the confirmation message to the dialogue system based on artificial intelligence as context information. A dialogue-based user guidance can be efficiently started in a proactive manner in this way.

According to a further advantageous design, providing a first message of the dialogue-based user guidance by way of the rule-based dialogue system of the digital assistant to a user of the vehicle after activating the dialogue-based user guidance can comprise receiving a system status of the function of the vehicle by way of the rule-based dialogue system of the digital assistant, transferring a text message representatives of the system status of the function of the vehicle to the dialogue system based on artificial intelligence by way of the rule-based dialogue system of the digital assistant as context information, and providing the first message of the dialogue-based user guidance by way of the rule-based dialogue system of the digital assistant to a user of the vehicle depending on the system status of the function of the vehicle. A system status of the function of the vehicle can be efficiently provided as context information to the dialogue system based on artificial intelligence in this way.

According to a further advantageous design, recognizing the intent of the dialogue-based user guidance of the rule-based dialogue system depending on the received message of the user by way of the rule-based dialogue system of the digital assistant can comprise determining a confidence value of the intent of the dialogue-based user guidance of the rule-based dialogue system depending on the received message of the user by way of the rule-based dialogue system of the digital assistant. The intent can be determined more precisely by the rule-based dialogue system in this way.

According to a further advantageous design, the method can furthermore comprise, if no intent of the dialogue-based user guidance of the rule-based dialogue system on the function of the vehicle was recognized by the rule-based dialogue system of the digital assistant or the confidence value of the recognized intent of the dialogue-based user guidance of the rule-based dialogue system on the function of the vehicle by way of the rule-based dialogue system of the digital assistant is less than a predetermined confidence threshold value, providing a context-based response message to the user of the vehicle by way of the dialogue system of the digital assistant based on artificial intelligence using the transferred context information and depending on the transferred message of the user and, if the confidence value of the recognized intent of the dialogue-based user guidance H the rule-based dialogue system on the function of the vehicle by the rule-based dialogue system of the digital assistant is greater than or equal to the predetermined confidence threshold value, providing a response message to the user of the vehicle depending on the recognized intent of the dialogue-based user guidance of the rule-based dialogue system on the function of the vehicle by way of the rule-based dialogue system of the vehicle. Providing the context-based response message can be controlled more efficiently in this way.

According to a further advantageous design, the context-based response message can be provided to the user of the vehicle by the dialogue system of the digital assistant based on artificial intelligence using all context information which was transferred to the dialogue system based on artificial intelligence after the activation of the dialogue-based user guidance by the rule-based dialogue system. A dialogue-based context for the dialogue system based on artificial intelligence can be efficiently defined in this way.

According to a further advantageous design, the context-based response message to the user of the vehicle by way of the dialogue system of the digital assistant based on artificial intelligence can be provided using at least one or all items of context information which were transferred to the dialogue system based on artificial intelligence after the activation of the dialogue-based user guidance by the rule-based dialogue system, and depending on the intent and/or the confidence value of the intent of the dialogue-based user guidance of the rule-based dialogue system of the digital assistant. A dialogue-based context for the dialogue system based on artificial intelligence can be defined efficiently in this way.

According to a further aspect, the disclosure is directed to a computer-readable medium for operating a digital assistant of a vehicle, wherein the computer-readable medium comprises instructions which, when they are executed on a computer and/or a controller, carry out the above-described method. As used herein, a “control unit” refers to a computer and/or controller and/or processor. Control units may include circuits (e.g., integrated circuits) that contain typical functionality of central processing units (CPU) and are configured to perform various calculations and analysis. Examples of control units used in vehicles include any of various Engine Control Units (ECUs) as commonly used by different vehicle manufacturers in modern automobiles.

According to a further aspect, the disclosure is directed to a system for operating a digital assistant of a vehicle, wherein the system is designed to carry out the above-described method.

According to a further aspect, the disclosure is directed to a vehicle comprising the above-describe system for operating a digital assistant of the vehicle.

Further features of the disclosure result from the claims, the figure, and the description of the figure. All features and combinations of features mentioned above in the description and the features and combinations of features mentioned hereinafter in the description of the figures and/or solely shown in the figure are usable not only in the respective indicated combination, but also in other combinations or alone.

### BRIEF DESCRIPTION OF THE DRAWING

A preferred exemplary embodiment of the disclosure is described hereinafter on the basis of the appended drawing. Further details, preferred designs, and refinements of the disclosure result therefrom. Specifically,

FIG. 1 is a schematic showing an exemplary method for operating a digital assistant of a vehicle.

### DESCRIPTION

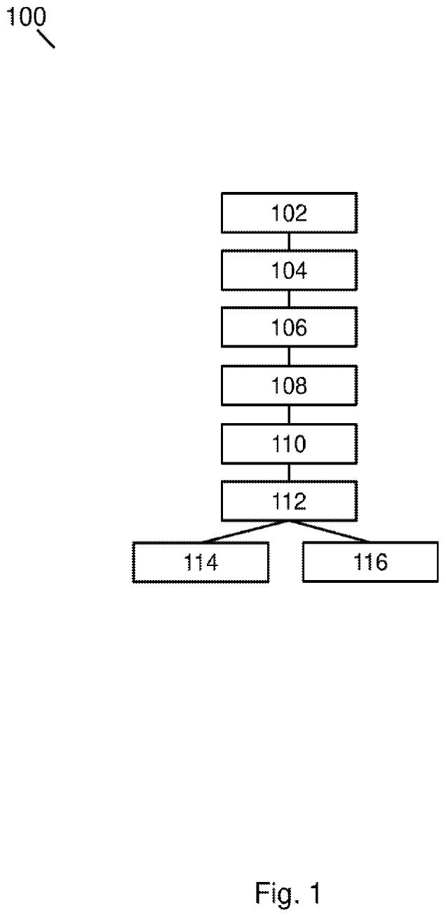

In detail, FIG. 1 shows an exemplary method 100 for operating a digital assistant of a vehicle. The digital assistant of the vehicle can comprise a rule-based dialogue system and a dialogue system based on artificial intelligence. For example, the rule-based dialogue system can comprise a deterministic speech model. The deterministic speech model can recognize pre-modeled intents and generate associated deterministic response messages and/or provide them to a user of the vehicle. For example, the rule-based dialogue system can comprise a predetermined multistep dialogue on a function of the vehicle. The predetermined multistep dialogue on a function of the vehicle can comprise a technically correct user guidance on a function of the vehicle.

For example, the dialogue system based on artificial intelligence can be a chatbot, which uses an artificial intelligence, for example a machine learning method, in order to generate and/or provide speech-based and/or text-based response messages for a user. The dialogue system based on artificial intelligence can be trained, for example, in multiple steps using a speech model. The dialogue system based on artificial intelligence can be trained using technically correct data on a function of the vehicle as training data. For example, the dialogue system based on artificial intelligence can be trained using a user handbook and/or a technical specification of the vehicle, and in particular using a user handbook and/or a technical specification on a function of the vehicle, as training data.

The method 100 comprises activating 102 a dialogue-based user guidance of the rule-based dialogue system on a function of the vehicle by the rule-based dialogue system of the digital assistant. The dialogue-based user guidance can comprise multiple dialogue steps. The dialogue-based user guidance can explain a correct use of the function of the vehicle to the user of the vehicle step-by-step on the basis of a predetermined sequence of dialogue steps. For example, the function of the vehicle can be a parking assistance function of the vehicle. The dialogue-based user guidance of the parking assistance function of the vehicle can comprise multiple dialogue steps of which actions of the user are to be carried out for a correct use of the parking assistance function. For example, a first dialogue step can instruct the user to drive at a predetermined maximum speed with a predetermined maximum distance to parked vehicles. In a second dialogue step, the vehicle can suggest a parking space to the user which matches with the vehicle of the user and further actions of the user after the parking place suggestion of the vehicle. In a third dialogue step, the vehicle can prompt the user to take his hands off of the steering wheel. In a fourth dialogue step, the vehicle can prompt the user to take his foot off the brake pedal. In a fifth dialogue step, the vehicle can instruct the user to let the vehicle carry out parking of the vehicle, wherein a speed of the vehicle can be controlled by the user via an actuation of the brake pedal. In a sixth dialogue step, the vehicle can transmit a message about successful parking of the vehicle to the user of the vehicle.

The method 100 comprises providing 104 a first message of the dialogue-based user guidance by way of the rule-based dialogue system of the digital assistant to a user of the vehicle after the activation of the dialogue-based user guidance. The first message can be a proactive recommendation on a function of the vehicle. Furthermore, the method 100 can transfer 106 the first message of the dialogue-based user guidance from the rule-based dialogue system of the digital assistant to the dialogue system of the digital assistant based on artificial intelligence as context information. The user can optionally transfer a message to accept or decline the recommendation on the function of the vehicle to the rule-based dialogue system.

If the user accepts the recommendation on the function of the vehicle, the method can carry out the dialogue-based user guidance on the function of the vehicle. Each dialogue step of the dialogue-based user guidance can be transferred by the rule-based dialogue system and the dialogue system based on artificial intelligence as context information. In the example of the dialogue-based user guidance on the parking assistant, the rule-based dialogue system can transfer messages to the user of the vehicle and/or sensor information of the respective dialogue step to the dialogue system based on artificial intelligence as context information.

The method 100 can receive 108 a message of the user during the dialogue-based user guidance of the rule-based dialogue system by way of the rule-based dialogue system of the digital assistant and transfer 110 the message of the user from the rule-based dialogue system of the digital assistant to the dialogue system of the digital assistant based on artificial intelligence. Furthermore, the method 100 can recognize 112 an intent of the dialogue-based user guidance of the rule-based dialogue system on the function of the vehicle depending on the received message of the user by way of the rule-based dialogue system of the digital assistant. In the example of the dialogue-based user guidance of the parking assistant, in the third dialogue step, taking his hands off of the steering wheel can be a message of the user which is recognized by the method 100 as the intent to continue the dialogue-based user guidance of the parking assistant. Furthermore, the message can be, for example, a speech message of the user, using which the user of the vehicle wishes to inquire whether, for example, he is doing everything correctly or is uncertain whether the operation is correct. If no intent for this speech message is defined in the rule-based dialogue system, the method 100 also cannot recognize an intent.

If no intent of the dialogue-based user guidance of the rule-based dialogue system on the function of the vehicle was recognized by the rule-based dialogue system of the digital assistant, the method 100 can provide 114 a context-based response message to the user of the vehicle by way of the dialogue system of the digital assistant based on artificial intelligence using the transferred context information and depending on the transferred message of the user. If an intent of the dialogue-based user guidance of the rule-based dialogue system on the function of the vehicle was recognized by the rule-based dialogue system of the digital assistant, the method can provide 116 response message, in particular a predefined response message, to the user of the vehicle depending on the recognized intent of the dialogue-based user guidance of the rule-based dialogue system on the function of the vehicle by way of the rule-based dialogue system of the vehicle.

Advantageously, the dialogue system based on artificial intelligence, for example a dialogue system which uses a large language model and one or more machine learning methods, can provide a response message to a message of the user, for which no intent can be recognized by the rule-based dialogue system. The rule-based dialogue system can comprise, for example, a deterministic language model, which enables a recognition of intents, and a communicative coupling to onboard network signals and/or onboard network messages, which can be used by the rule-based dialogue system in order to control the dialogue-based user guidance. The dialogue-based user guidance of the rule-based dialogue system can use the method as context for the dialogue system based on artificial intelligence in order to respond to messages of the user in a context-based manner, in particular to respond if there is no intent or a confidence of a recognized intent falls below a predetermined confidence threshold value. The rule-based dialogue system results in increased functional and/or usage reliability of the digital assistant, since the rule-based dialogue system provides correct and secured, safety-relevant information in the dialogue-based user guidance. In addition, the digital assistant can freely interpret messages of the user in the context of a currently performed dialogue-based user guidance and the learned factual knowledge and therefore efficiently provide more extensive information to the user in context-based response messages.

### LIST OF REFERENCE SIGNS

100 method
102 activating a dialogue-based user guidance
104 providing a first message
106 transferring the first message
108 receiving a message
110 transferring the message
112 recognizing an intent
114 providing a context-based response message
116 providing a response message

1-10. (canceled)

11. A method for operating a digital assistant of a vehicle, wherein the digital assistant comprises a rule-based dialogue system and a dialogue system based on artificial intelligence, the method comprising:
activating a dialogue-based user guidance of the rule-based dialogue system on a function of the vehicle by way of the rule-based dialogue system of the digital assistant;
providing a first message of the dialogue-based user guidance by way of the rule-based dialogue system of the digital assistant to a user of the vehicle after the activation of the dialogue-based user guidance;
transferring the first message of the dialogue-based user guidance from the rule-based dialogue system of the digital assistant to the dialogue system of the digital assistant based on artificial intelligence as context information;
receiving a message of the user during the dialogue-based user guidance of the rule-based dialogue system by way of the rule-based dialogue system of the digital assistant;
transferring the message of the user from the rule-based dialogue system of the digital assistant to the dialogue system of the digital assistant based on artificial intelligence;
recognizing an intent of the dialogue-based user guidance of the rule-based dialogue system on the function of the vehicle depending on the received message of the user by way of the rule-based dialogue system of the digital assistant;
if no intent of the dialogue-based user guidance of the rule-based dialogue system on the function of the vehicle has been recognized by the rule-based dialogue system of the digital assistant:
providing a context-based response message to the user of the vehicle by way of the dialogue system of the digital assistant based on artificial intelligence using the transferred context information and depending on the transferred message of the user; and
if an intent of the dialogue-based user guidance of the rule-based dialogue system on the function of the vehicle has been recognized by the rule-based dialogue system of the digital assistant:
providing a response message to the user of the vehicle depending on the recognized intent of the dialogue-based user guidance of the rule-based dialogue system on the function of the vehicle by way of the rule-based dialogue system of the vehicle.

12. The method according to claim 11, wherein the activation of the dialogue-based user guidance on the function of the vehicle by the rule-based dialogue system of the digital assistant comprises:
providing a recommendation message on a function of a vehicle by way of the rule-based dialogue system of the digital assistant to a user of the vehicle;
transferring the recommendation message to the dialogue system based on artificial intelligence as context information;
receiving a confirmation message of the user of the vehicle in response to be provided recommendation message by way of the rule-based dialogue system of the digital assistant to activate the dialogue-based user guidance on the function of the vehicle;
activating the dialogue-based user guidance of the function of the vehicle by way of the rule-based dialogue system of the digital assistant; and
transferring the confirmation message to the dialogue system based on artificial intelligence as context information.

13. The method according to claim 12, wherein providing the first message of the dialogue-based user guidance by the rule-based dialogue system of the digital assistant to a user of the vehicle after the activation of the dialogue-based user guidance comprises:
receiving a system status of the function of the vehicle by way of the rule-based dialogue system of the digital assistant;
transferring a text message representative of the system status of the function of the vehicle to the dialogue system based on artificial intelligence by way of the rule-based dialogue system of the digital assistant as context information; and
providing the first message of the dialogue-based user guidance by way of the rule-based dialogue system of the digital assistant to a user of the vehicle depending on the system status of the function of the vehicle.

14. The method according to claim 13, wherein recognizing the intent of the dialogue-based user guidance of the rule-based dialogue system depending on the received message of the user by way of the rule-based dialogue system of the digital assistant comprises:
determining a confidence value of the intent of the dialogue-based user guidance of the rule-based dialogue system depending on the received message of the user by way of the rule-based dialogue system of the digital assistant.

15. The method according to claim 14, the method furthermore comprising:
if no intent of the dialogue-based user guidance of the rule-based dialogue system on the function of the vehicle was recognized by the rule-based dialogue system of the digital assistant or the confidence value of the recognized intent of the dialogue-based user guidance of the rule-based dialogue system on the function of the vehicle by the rule-based dialogue system of the digital assistant is less than a predetermined confidence threshold value:
providing a context-based response message to the user of the vehicle by way of the dialogue system of the digital assistant based on artificial intelligence using the transferred context information and depending on the transferred message of the user.

16. The method according to claim 14, the method further comprising:
if the confidence value of the recognized intent of the dialogue-based user guidance of the rule-based dialogue system on the function of the vehicle by the rule-based dialogue system of the digital assistant is greater than or equal to a predetermined confidence threshold value:
providing a response message to the user of the vehicle depending on the recognized intent of the dialogue-based user guidance of the rule-based dialogue system on the function of the vehicle by way of the rule-based dialogue system of the vehicle.

17. The method according to claim 14, wherein the context-based response message to the user of the vehicle by the dialogue system of the digital assistant based on artificial intelligence is provided using all context information which was transferred to the dialogue system based on artificial intelligence after the activation of the dialogue-based user guidance by the rule-based dialogue system.

18. The method according to claim 17, wherein the context-based response message to the user of the vehicle by the dialogue system of the digital assistant based on artificial intelligence is provided using at least one or all items of context information which were transferred to the dialogue system based on artificial intelligence after the activation of the dialogue-based user guidance by the rule-based dialogue system, and depending on the intent and/or the confidence value of the intent of the dialogue-based user guidance of the rule-based dialogue system of the digital assistant.

19. A non-transitory computer-readable medium for operating a digital assistant of a vehicle, wherein the computer-readable medium comprises instructions which, when they are executed on a control unit, carry out the method according to claim 11.

20. A system for operating a digital assistant of a vehicle, wherein the system is designed to carry out the method according to claim 11.

21. A vehicle comprising the system for operating a digital assistant of a vehicle according to claim 20.

22. A method for operating a digital assistant of a vehicle, wherein the digital assistant comprises a rule-based dialogue system and a dialogue system based on artificial intelligence, the method comprising:
activating a dialogue-based user guidance of the rule-based dialogue system on a function of the vehicle by way of the rule-based dialogue system of the digital assistant;
providing a first message of the dialogue-based user guidance by way of the rule-based dialogue system of the digital assistant to a user of the vehicle after the activation of the dialogue-based user guidance;
transferring the first message of the dialogue-based user guidance from the rule-based dialogue system of the digital assistant to the dialogue system of the digital assistant based on artificial intelligence as context information;
receiving a message of the user during the dialogue-based user guidance of the rule-based dialogue system by way of the rule-based dialogue system of the digital assistant;
transferring the message of the user from the rule-based dialogue system of the digital assistant to the dialogue system of the digital assistant based on artificial intelligence;
recognizing an intent of the dialogue-based user guidance of the rule-based dialogue system on the function of the vehicle depending on the received message of the user by way of the rule-based dialogue system of the digital assistant; and
if no intent of the dialogue-based user guidance of the rule-based dialogue system on the function of the vehicle has been recognized by the rule-based dialogue system of the digital assistant:
providing a context-based response message to the user of the vehicle by way of the dialogue system of the digital assistant based on artificial intelligence using the transferred context information and depending on the transferred message of the user.

23. The method according to claim 22, wherein the activation of the dialogue-based user guidance on the function of the vehicle by the rule-based dialogue system of the digital assistant comprises:
providing a recommendation message on a function of a vehicle by way of the rule-based dialogue system of the digital assistant to a user of the vehicle;
transferring the recommendation message to the dialogue system based on artificial intelligence as context information;
receiving a confirmation message of the user of the vehicle in response to be provided recommendation message by way of the rule-based dialogue system of the digital assistant to activate the dialogue-based user guidance on the function of the vehicle;
activating the dialogue-based user guidance of the function of the vehicle by way of the rule-based dialogue system of the digital assistant; and
transferring the confirmation message to the dialogue system based on artificial intelligence as context information.

24. The method according to claim 22, wherein providing the first message of the dialogue-based user guidance by the rule-based dialogue system of the digital assistant to a user of the vehicle after the activation of the dialogue-based user guidance comprises:
receiving a system status of the function of the vehicle by way of the rule-based dialogue system of the digital assistant;
transferring a text message representative of the system status of the function of the vehicle to the dialogue system based on artificial intelligence by way of the rule-based dialogue system of the digital assistant as context information; and
providing the first message of the dialogue-based user guidance by way of the rule-based dialogue system of the digital assistant to a user of the vehicle depending on the system status of the function of the vehicle.

25. The method according to claim 22, wherein recognizing the intent of the dialogue-based user guidance of the rule-based dialogue system depending on the received message of the user by way of the rule-based dialogue system of the digital assistant comprises:
determining a confidence value of the intent of the dialogue-based user guidance of the rule-based dialogue system depending on the received message of the user by way of the rule-based dialogue system of the digital assistant.

26. A method for operating a digital assistant of a vehicle, wherein the digital assistant comprises a rule-based dialogue system and a dialogue system based on artificial intelligence, the method comprising:
activating a dialogue-based user guidance of the rule-based dialogue system on a function of the vehicle by way of the rule-based dialogue system of the digital assistant;
providing a first message of the dialogue-based user guidance by way of the rule-based dialogue system of the digital assistant to a user of the vehicle after the activation of the dialogue-based user guidance;
transferring the first message of the dialogue-based user guidance from the rule-based dialogue system of the digital assistant to the dialogue system of the digital assistant based on artificial intelligence as context information;
receiving a message of the user during the dialogue-based user guidance of the rule-based dialogue system by way of the rule-based dialogue system of the digital assistant;
transferring the message of the user from the rule-based dialogue system of the digital assistant to the dialogue system of the digital assistant based on artificial intelligence;
recognizing an intent of the dialogue-based user guidance of the rule-based dialogue system on the function of the vehicle depending on the received message of the user by way of the rule-based dialogue system of the digital assistant; and
if an intent of the dialogue-based user guidance of the rule-based dialogue system on the function of the vehicle has been recognized by the rule-based dialogue system of the digital assistant:
providing a response message to the user of the vehicle depending on the recognized intent of the dialogue-based user guidance of the rule-based dialogue system on the function of the vehicle by way of the rule-based dialogue system of the vehicle.

27. The method according to claim 26, wherein the activation of the dialogue-based user guidance on the function of the vehicle by the rule-based dialogue system of the digital assistant comprises:
providing a recommendation message on a function of a vehicle by way of the rule-based dialogue system of the digital assistant to a user of the vehicle;
transferring the recommendation message to the dialogue system based on artificial intelligence as context information;
receiving a confirmation message of the user of the vehicle in response to be provided recommendation message by way of the rule-based dialogue system of the digital assistant to activate the dialogue-based user guidance on the function of the vehicle;
activating the dialogue-based user guidance of the function of the vehicle by way of the rule-based dialogue system of the digital assistant; and
transferring the confirmation message to the dialogue system based on artificial intelligence as context information.

28. The method according to claim 26, wherein providing the first message of the dialogue-based user guidance by the rule-based dialogue system of the digital assistant to a user of the vehicle after the activation of the dialogue-based user guidance comprises:
receiving a system status of the function of the vehicle by way of the rule-based dialogue system of the digital assistant;
transferring a text message representative of the system status of the function of the vehicle to the dialogue system based on artificial intelligence by way of the rule-based dialogue system of the digital assistant as context information; and
providing the first message of the dialogue-based user guidance by way of the rule-based dialogue system of the digital assistant to a user of the vehicle depending on the system status of the function of the vehicle.

29. The method according to claim 26, wherein recognizing the intent of the dialogue-based user guidance of the rule-based dialogue system depending on the received message of the user by way of the rule-based dialogue system of the digital assistant comprises:
determining a confidence value of the intent of the dialogue-based user guidance of the rule-based dialogue system depending on the received message of the user by way of the rule-based dialogue system of the digital assistant.
